(19) United States
(12) Patent Application Publication
(10) Pub. No.: US 2026/0339814 A1
(43) Pub. Date: Oct. 29, 2026

(54) AUTOMATED DATA LOG FILTERING

(71) Applicant: International Business Machines Corporation, Armonk, NY (US)

(72) Inventors: Gideon Sireling, Jerusalem (IL); Santosh Rajashekar, Bangalore (IN); Xavier Santolaria, Begnins (CH)

(21) Appl. No.: 19/189,047

(22) Filed: Apr. 24, 2025

(51) Int. Cl. G06F 11/34; G06F 11/07; G06F 40/20; G06N 20/00

(52) U.S. Cl. CPC G06F 11/3476; G06F 40/20; G06N 20/00; G06F 11/0769

(57) ABSTRACT

A method, according to one approach, includes: receiving incident data logs from a system. The method also includes using trained AI based models to: evaluate the incident data logs in view of log retention thresholds and compliance constraints. The AI based models are further used to classify the incident data logs based at least in part on their respective utility in incident detection and resolution. Additionally, the AI based models are used to determine whether any of the incident data logs should be ingested. The method also includes causing a feature selection algorithm to supplement the incident data logs output by the trained AI based models. Furthermore, the supplemented incident data logs are ingested.

### BACKGROUND

The present invention relates to data analysis, and more specifically, this invention relates to selecting specific subsets of data logs.

Data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does the overhead associated with processing the data. This is particularly true for metrics. For instance, the surge in the complexity of modern applications, especially those built on microservices architectures, has led to an increase in the volume of metrics that is produced. This data encompasses various streams, including logs, metrics, traces, etc.

### SUMMARY

A method, according to one approach, includes: receiving incident data logs from a system. The method also includes using trained AI based models to: evaluate the incident data logs in view of log retention thresholds and compliance constraints. The AI based models are further used to classify the incident data logs based at least in part on their respective utility in incident detection and resolution. Additionally, the AI based models are used to determine whether any of the incident data logs should be ingested. The method also includes causing a feature selection algorithm to supplement the incident data logs output by the trained AI based models. Furthermore, the supplemented incident data logs are ingested.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a detailed view of the distributed system in FIG. 2A, in accordance with one approach.

FIG. 3A is a flowchart of a method, in accordance with one approach.

FIG. 3B is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamically optimizing data log storage and processing in accordance with one approach. Approaches herein are able to learn to identify and classify log sources based at least in part on their respective usefulness for incident detection, analysis, and resolution. This is achieved by at least some of the approaches herein by leveraging machine learning models trained on historical incident data to classify logs in real-time, thereby ensuring critical logs are retained while minimizing resource consumption, e.g., as will be described in further detail below.

In one general approach, a method includes receiving incident data logs from a system. The method also includes using trained AI based models to: evaluate the incident data logs in view of log retention thresholds and compliance constraints. The AI based models are further used to classify the incident data logs based at least in part on their respective utility in incident detection and resolution. Additionally, the AI based models are used to determine whether any of the incident data logs should be ingested. The method also includes causing a feature selection algorithm to supplement the incident data logs output by the trained AI based models. Furthermore, the supplemented incident data logs are ingested.

In another general approach, a computer program product includes one or more computer-readable storage media. The computer program product also includes program instructions that are stored on the one or more storage media to perform the foregoing method.

In another general approach, a computer system includes a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data log selection code in block 150 for dynamically optimizing data log storage and processing in accordance with one approach. Approaches herein are able to learn to identify and classify log sources based at least in part on their respective usefulness for incident detection, analysis, and resolution. This is achieved by at least some of the approaches herein by leveraging machine learning models trained on historical incident data to classify logs in real-time, thereby ensuring critical logs are retained while minimizing resource consumption, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

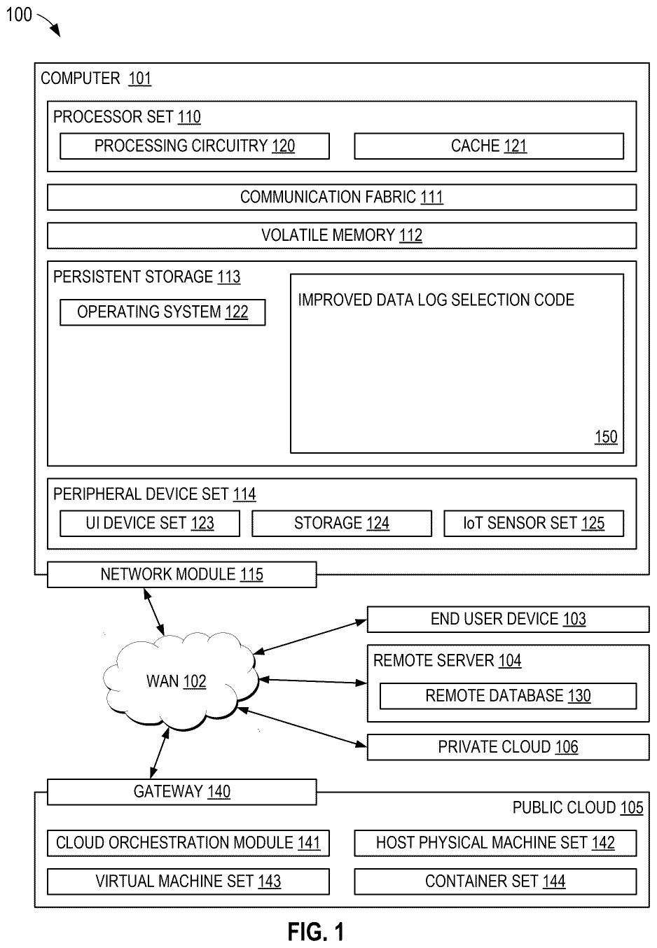

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By “integrated with,” what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does the overhead associated with processing the data. This is particularly true for data logs. For instance, the surge in the complexity of modern applications, especially those built on microservices architectures, has led to a substantial increase in the volume of data logs that are produced. For example, in the realm of cybersecurity, the escalating volume and diversity of logs generated by systems pose significant challenges. The burgeoning cost associated with storing and processing these logs within systems like Security Information and Event Management (SIEM) has become a pressing concern for organizations worldwide.

The ongoing dilemma revolves around determining which logs are truly pivotal for security analysis and incident response amidst the deluge of data. Current practices lack the precision and data-driven insights necessary to make informed decisions regarding log retention, leading to inefficient resource allocation and inflated operational expenses. Analyzing each and every log is cumbersome, resource-intensive, and even impossible in some situations due to the sheer volume of information that is generated. This complexity can overwhelm traditional monitoring tools and methods, making it challenging to identify critical issues or performance bottlenecks. This is particularly true in systems that rely on real-time analysis. Even advanced analytical techniques, e.g., such as Artificial Intelligence for IT Operations (AIOps), driven automated anomaly detection, root cause analysis, failure and outage prediction, etc. are overwhelmed with large volumes of logs and suffer from the “garbage in, garbage out” (GIGO) principle, producing poor quality determinations. Thus, there exists a need for revolutionized log management practices which are able to not only addresses the burgeoning costs associated with the increased information, as well as enhancing the efficacy of incident detection and analysis.

In sharp contrast to the foregoing shortcomings that are experienced by conventional products, approaches herein are desirably able to identify useful (e.g., relevant) subsets of a large amount of logs. For instance, approaches herein are able to build and train AI based models that are configured to optimize log storage and processing by identifying and classifying log sources based on their respective usefulness for incident detection, analysis, and resolution. This is achieved by at least some of the approaches herein by leveraging machine learning models trained on historical incident data to classify logs in real-time, thereby ensuring critical logs are retained while minimizing resource consumption. The overarching system also continuously refines the decision-making performed by the various AI based models by implementing feedback loops and NLP-driven incident analysis.

Approaches herein are thereby able to identify relevant subsets of data logs that provide rich information, and remove remaining data logs from evaluation. This reduces the logs that are evaluated by removing content that does not provide rich insight. Approaches herein thereby desirably identify which data logs are informative and which are not. Systems are able to operate more efficiently as a result, because metrics that provide the same or similar information about performance are not processed multiple times, e.g., as will be described in further detail below.

It follows that in response to the pressing need for more efficient log management, approaches herein utilize machine learning and adaptive analytics to gain an insight to received data logs. These advanced algorithms allow for significant improvements to be made to log storage and processing. As alluded to above, approaches herein discern the indispensable log sources and parameters crucial for security analysis while streamlining the exclusion of redundant or superfluous data. The approaches are adaptive in nature, and capable of dynamically adjusting log filtering strategies in response to evolving threat landscapes and compliance standards. By striking a delicate balance between resource optimization and security efficacy, approaches herein are able to usher in a new era in log management practices.

These improvements are also achieved at least in part as a result of seamless integration of machine learning algorithms into the fabric of log management systems. Through iterative analysis of historical events and incident responses, approaches herein works to ascertain the intrinsic value of each log source and parameter. This insight may be further supplemented by inputs provided by incident responders, e.g., through post-event labelling of logs based on their respective utility. This knowledge allows the system to employ sophisticated algorithms that are configured (e.g., trained) to make informed decisions regarding log retention and analysis levels, e.g., ranging from real-time monitoring to batch processing. This adaptive approach ensures that resources are allocated judiciously, maximizing operational efficiency without compromising on security vigilance, e.g., as will be described in further detail below.

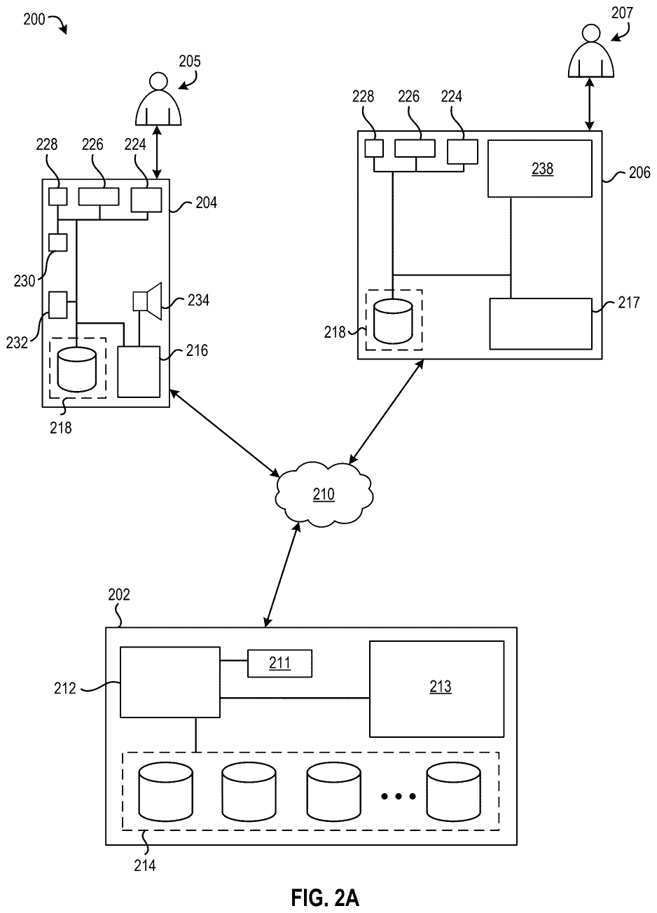

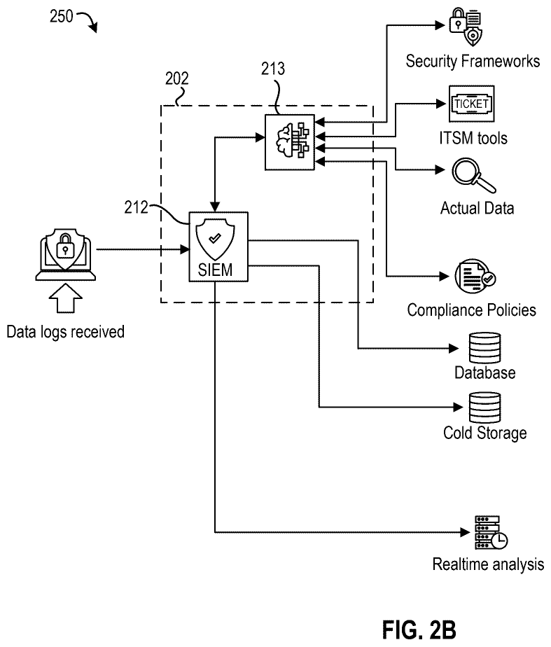

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The user device 204 and edge node 206 may thereby be considered “endpoint devices,” each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. Moreover, ones of these models in the AI module 213 may be configured to interact with the processor 212 and applications running therein. For example, the AI module 213 may interact (e.g., exchange information) with SIEM based applications that are running in the processor 212, e.g., to monitor received incident data logs and identify relevant subsets for ingestion.

As used herein, “incident data logs” are collections of data that may include different types of information. According to one non-limiting example, the incident data logs may include any collections (e.g., logs) that may be ingested into SIEMs. For instance, the incident data logs may include the general log output of applications (and devices), automated logs from security incidents (e.g., that are often produced by the SIEM itself), performance monitors, etc., or any other electronic log records and/or combinations thereof. According to another non-limiting example, the incident data logs in information technology service management (ITSM) systems may include any information that is related to security incidents. For instance, in situations where human operators and automated processes record the history of how an incident was detected and processed. These incident data logs may be used to analyse which log sources and/or fields from the previous point were helpful. It should also be noted that while various approaches herein are described in the context of evaluating incident data logs that are received from SIEMs, these approaches may be applied to other types of data logs. Applying approaches herein to implementations that utilize Extended Detection and Response (XDR) data logs would further improve focused logs and increase their efficiency, along with improving the accuracy of detection and response. Similarly, approaches herein may be applied to Endpoint Detection and Response (EDR) data logs, resulting in better focused logs which would increase their efficiency, while also improving the accuracy of detection and response. It follows that the approaches herein are able to successfully increase efficiency by lowering processing and storage costs, which in turn reduces the time to detect and time to respond to potential incidents (e.g., threats).

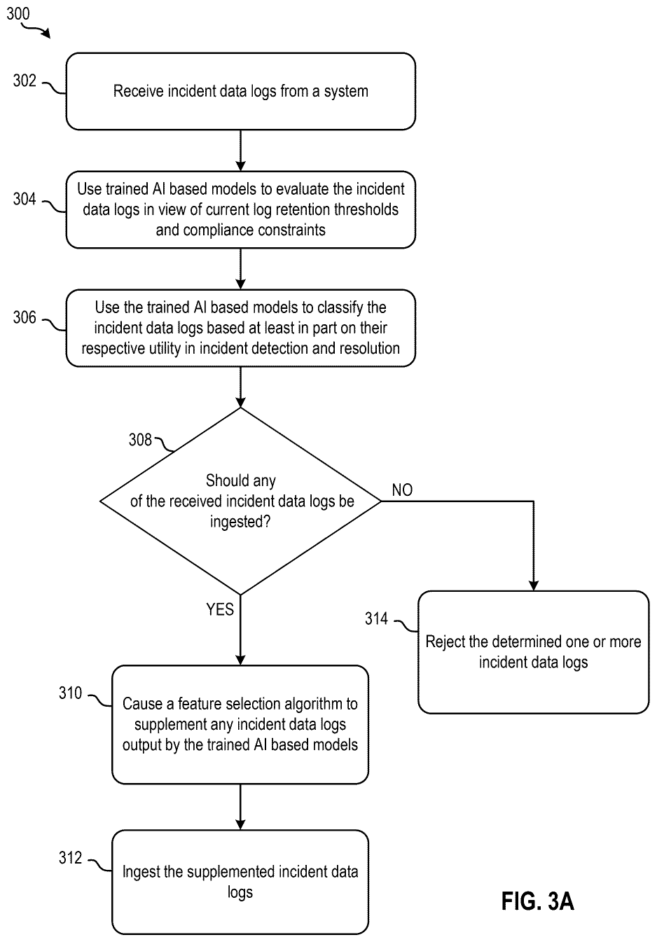

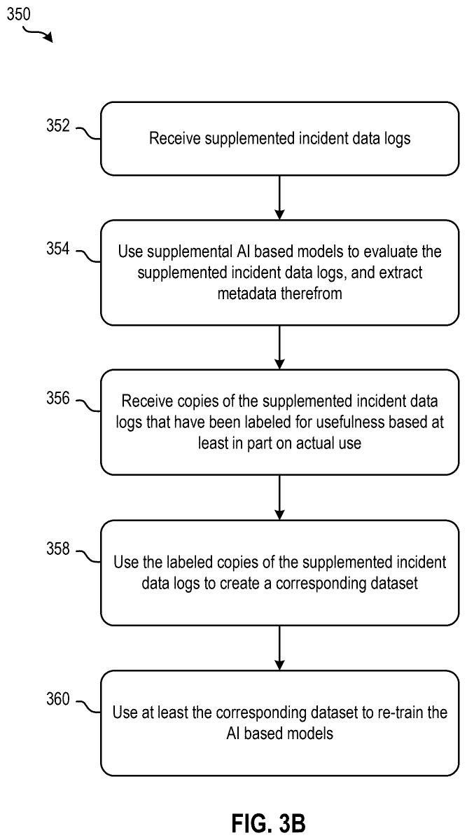

Looking still to FIG. 2A, the AI module 213 includes AI based models that are trained to evaluate and classify received incident data logs (or any logs for that matter) based at least in part on their respective utility in incident detection and resolution for the respective system. The AI based models may further be incrementally re-trained as data logs are ingested and real-world utility metrics (e.g., labeled data logs) are received for the data logs that were ingested. These metrics are received and evaluated over time, thereby providing a dynamic ability to adjust incident data log retention levels, compute consumption percentages, etc., that are implemented across the overarching system. This allows approaches herein to react to in real-time and provide an accurate assessment of potential security threats while also maintaining desirable compute throughput and system performance. As noted above, this has previously been unachievable due to the intense compute workloads associated with conventional product performance. AI module 213 and/or processor 212 may thereby be used to perform one or more of the operations in method 300 of FIG. 3A, e.g., as will be described in further detail below.

Referring now momentarily to FIG. 2B, a detailed diagram 250 outlining the connections between various aspects of components in the system 200 of FIG. 2A is illustrated in accordance with one approach which is in no way intended to be limiting. Any of the details shown in FIG. 2B and/or described herein may be implemented in FIG. 2A, e.g., as would be appreciated by one skilled in the art after reading the present description.

As shown, data logs are received at processor 212 of central server 202 from various endpoints, servers, networks, running applications, AI based models, security devices, cloud resources, etc. As noted above, these data logs may be incident data logs which are related to security of the system 200. (e.g., cybersecurity). There, processor 212 utilizes SIEM along with one or more AI based models in AI module 213 to evaluate the received data logs. For instance, AI module 213 includes AI based models therein that have been trained to use machine learning to extract information from Security Frameworks (e.g., from NIST, MITTRE, etc.) to understand the fields and/or properties that are correlated with expected standards. Similarly, standards are extracted from Compliance Policies. For instance, AI based models are trained based on information in the compliance policies that provide insight into desired metrics.

The AI based models in AI module 213 are also trained using tools that are associated with expected standards. For example, AI module 213 communicates with ITSM tools in some approaches to extract different standards. The AI based models in AI module 213 are also trained based on Actual Data, e.g., such as real use cases experienced, frequently searched fields in the SIEM, etc. This training will also allow the models to identify fields that are not used as part of correlation or searches over time, and eliminate them from being ingested.

As noted above, these AI based models are used to evaluate incoming data logs and determine which (if any) should be ingested by the system. Accordingly, processor 212 may cause select data logs to be stored in a Database and/or Cold Storage. For example, the Cold Storage may include cloud storage that provides supplemental data storage capacity. SIEM is thereby able to selectively store full (e.g., unabridged) data logs to cloud storage, while maintaining only relevant ones thereof in the Database for easy access and analysis. Furthermore, the processor 212 is configured to produce Realtime Analysis or a dynamic synopsis of what adjustments have been made to data log retention and how that is impacting performance of the system as a whole. The Realtime Analysis may thereby be fed back into the AI module 213 to re-train AI based models therein (not shown).

With continued reference to FIG. 2A, the terms “user” and “administrator” are in no way intended to be limiting either. For instance, while users and administrators may be described as being individuals in various implementations herein, a user and/or an administrator may be an application, an organization, a preset process, etc. The use of “data,” “data logs,” and “information” herein are in no way intended to be limiting either, and may include any desired type of details, e.g., depending on the type of operating system(s) implemented on the user device 204, edge node 206, and/or central server 202. In some approaches, security based incident data logs may be generated at the edge node 206 and send to the central server 202 for evaluation and potential processing. However, compute threshold is bounded, making any unnecessary overhead have a significant impact on performance overall. Thus, by evaluating incident data logs and choosing to only ingest (e.g., process) ones that are identified as providing rich information, approaches herein are desirably able to significantly reduce compute overhead. Moreover, these improvements may be tailored over time such that the system is able to adjust performance based on real-time feedback, allowing approaches herein to maintain operational efficiency over time. It should also be noted that approaches herein may be applied to any desired type of data logs. Thus, while various approaches are described in the context of security related incident data logs, this is in no way intended to be limiting.

User device 204 further includes a processor 216 which is coupled to memory 218. The processor 216 receives inputs from and interfaces with user 205. For instance, the user 205 may input information and/or queries using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include models that are trained to evaluate incident data logs and identify relevant portions therein. This may be based at least in part on the respective utility of each incident data log in incident detection and resolution for the respective system. The AI based models may further be incrementally re-trained as data logs are ingested and real-world utility metrics (e.g., labeled data logs) are received for the data logs that were ingested. These metrics are received and evaluated over time, thereby providing a dynamic ability to adjust incident data log retention levels, compute consumption percentages, etc., that are implemented across the overarching system. This allows approaches herein to react to in real-time and provide an accurate assessment of potential security threats while also maintaining desirable compute throughput and system performance. As noted above, this has previously been unachievable due to the intense compute workloads associated with conventional product performance. It follows that AI module 238 and/or controller 217 may be used to perform one or more of the operations in method 300 of FIG. 3A, e.g., as will be described in further detail below.

Looking now to FIG. 3A, a flowchart of a computer-implemented method 300 for dynamically optimizing data log storage and processing in accordance with one approach. Method 300 involves learning to identify and classify log sources based at least in part on their respective usefulness for incident detection, analysis, and resolution. This is achieved by at least some of the approaches herein by leveraging machine learning models trained on historical incident data to classify logs in real-time, thereby ensuring critical logs are retained while minimizing resource consumption. The overarching system also continuously refines the decision-making performed by the various AI based models by implementing feedback loops and NLP-driven incident analysis. In other words, method 300 may be performed to desirably reduce the number of data logs that are evaluated by removing information that is not “rich”. Approaches herein thereby have a concrete impact on the achievable throughput of a compute system.

Method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. For example, one or more processors located at a central server of a distributed system (e.g., see processor 212 of FIGS. 2A-2B above) may be used to perform one or more of the operations in method 300. In another example, one or more AI based models that have been trained and implemented in an AI module (e.g., see AI module 213 of FIGS. 2A-2B above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving incident data logs from a system. In other words, information associated with (e.g., outlining) security related events experienced by a system and/or one or more applications that are running therein, is received. The type, format, and/or number of incident data logs that are received in operation 302 may vary depending on the implementation. Incident data logs may be produced by a number of different applications, AI based models, microservices, programs, etc., that may be running on a given system. For instance, the incident data logs may include timeseries data outlining (e.g., associated with) performance health of the system, identified security threats, attempted infiltrations, etc. However, any desired type of incident data logs may be received from physical and/or logical components that are used to run the applications, microservices, programs, etc., e.g., as would be appreciated by one skilled in the art after reading the present description.

It should again be noted that while approaches herein describe the incident data logs in the context of potential cybersecurity related threats that arise, this is in no way intended to be limiting. In some approaches, additional information may also be received and used during the process of evaluating the received incident data logs. For instance, background information corresponding to the incident data logs may be received. In other words, details that describe certain characteristics of the incident data logs may also be received. According to another example, which again is in no way intended to limit the invention, a collection plan that includes details describing how the received incident data logs were generated may be obtained. In other words, information in the collection plan may outline operating settings, experienced errors, data collection methods, participants, etc., or any other relevant information about the incident data logs. This background information thereby provides useful insight into the received incident data logs and can be used to gain a better understanding of which portions of the incident data logs serve as rich datapoints. This supplemental information may further be used to re-train AI based models such that they have a detailed and dynamic understanding of system performance and how it may be impacted by security related threats.

Typically, a significant amount of data logs are generated by a system. As noted above, conventional products are overwhelmed attempting to process the sheer amount of data logs that are received over time. In sharp contrast, approaches herein are able to identify and classify log sources based on their respective usefulness for incident detection, analysis, and resolution. This is achieved by at least some of the approaches herein by leveraging AI based models that have been trained (e.g., using historical incident data) to classify data logs in real-time, thereby ensuring critical data logs are retained while minimizing resource consumption, e.g., as will be described in further detail below.

From operation 302, method 300 advances to operation 304. There, operation 304 includes using trained AI based models to evaluate the incident data logs in view of current log retention thresholds and compliance constraints. The AI based models are thereby configured to review regulatory thresholds regardless of utility assessments for incident handling. Moreover, by evaluating any compliance constraints, approaches herein are able to factor in various compliance standards, ensuring that log sources called-out for regulatory reasons are always retained, regardless of utility assessments for incident handling.

Log retention thresholds may also be used to help control the number, type, variety, etc., of the incident data logs that are ultimately ingested. The log retention thresholds are preferably adjusted over time to account for changes that occur in system performance, security threats, network traffic, etc., keeping the overall cost of ingesting relevant data logs at a desired level. For example, the log retention thresholds may be dynamically adjusted over time to maintain an about constant compute consumption rate for processing relevant incident data logs that are received. In another example, the log retention thresholds may be intentionally raised during periods of low network traffic and/or system compute, thereby utilizing available system throughput during slow times. It follows that approaches herein are able to dynamically adjust log retention thresholds in real-time based at least in part on evolving threat intelligence and compliance updates. Approaches herein are thereby able to implement dynamic thresholds that adjust based on identified risks (e.g., such as indicators of compromise, increased cyberattack activity, etc.), temporarily modifying log retention and analysis policies implemented in the system by AI based models as described herein.

Method 300 advances from operation 304 to operation 306. There, operation 306 includes using the trained AI based models to classify the incident data logs based at least in part on their respective utility in incident detection and resolution. In other words, the AI based models are able determine the relative utility of each received data log in incident detection and resolution based at least in part on the evaluation performed in operation 304. The AI based models may be of any desired type. In some approaches, the trained AI based models include supervised and/or unsupervised machine learning models. In some approaches, supervised models may be trained on past incident summaries, log source utility, performance metrics, log usefulness, etc., thereby gaining the ability to determine which (if any) of the received logs should be ingested by the system and which of the received logs should be rejected. Identification of a log or logs for which the determination is that it/they should be ingested and/or rejected may be output. Unsupervised machine learning models may learn (e.g., identify patterns) using any available information.

As noted above, the AI based models are trained using past performance to evaluate and classify received incident data logs based at least in part on their respective utility in incident detection and resolution for the respective system. The AI based models may further be incrementally re-trained as data logs are ingested and real-world utility metrics (e.g., labeled data logs) are received for the data logs that were ingested, e.g., as will be described in further detail below.

From operation 306, method 300 advances to operation 308. There, operation 308 includes using the AI based models to determine whether any of the incident data logs should be ingested. In other words, operation 308 includes using the AI based models to determine whether each of the incident data logs that have been received should be stored and/or processed by the system. Preferably, the incident data log(s) and/or identification(s) of the incident data log(s), for which the determination is that it/they should be ingested, is/are output.

In response to determining a given one or more of the received incident data logs should be processed and ingested by the system, method 300 advances from operation 308 to operation 310. There, operation 310 includes causing a feature selection algorithm to supplement any incident data logs output by the trained AI based models. In preferred approaches, the feature selection algorithm is configured to evaluate log sources, fields, and/or lines based on various topics which influence decisions on real-time analysis, batch processing, and storage. For example, the feature selection algorithm may apply a benefit-cost ratio to the incident data logs received and/or the specific logs output by the AI based models. In this example, a Benefit-Cost Ratio (BCR) framework with exponential scaling may be implemented to prioritize logs associated with high-severity incidents.

From operation 310, method 300 advances to operation 312. There, operation 312 includes ingesting the supplemented incident data logs. In other words, operation 312 includes processing and/or storing any incident data logs determined as being sufficiently relevant in operation 308 and/or identified by the feature selection algorithm.

Returning to operation 308, method 300 advances directly to operation 314 in response to identifying one or more of the received incident data logs as not being relevant or have a genuine impact on system security. This may be based at least in part on the respective utility of each incident data log in incident detection and resolution for the respective system. There, operation 314 includes rejecting the determined one or more incident data logs. In other words, operation 314 includes rejecting (denying) the one or more incident data logs identified as not being relevant, e.g., not providing information that is rich with respect to system security.

The AI based models may further be incrementally re-trained as data logs are ingested and real-world utility metrics (e.g., labeled data logs) are received for the data logs that were ingested, e.g., as will be described in further detail below. These metrics are received and evaluated over time, thereby providing a dynamic ability to adjust incident data log retention levels, compute consumption percentages, etc., that are implemented across the overarching system. This allows approaches herein to react to in real-time and provide an accurate assessment of potential security threats while also maintaining desirable compute throughput and system performance. As noted above, this has previously been unachievable due to the intense compute workloads associated with conventional product performance.

Accordingly, FIG. 3B illustrates a method 350 for re-training AI based models in accordance with one approach which is in no way intended to be limiting. Method 350 may be performed in accordance with the present invention in any of the environments depicted in FIGS. 1-2B, among others, in various approaches. Of course, more or less operations than those specifically described in FIG. 3B may be included in method 350, as would be understood by one of skill in the art upon reading the present descriptions. Each of the steps of the method 350 may be performed by any suitable component of the operating environment using known techniques and/or techniques that would become readily apparent to one skilled in the art upon reading the present disclosure. For example, one or more processors located at a central server of a distributed system (e.g., see processor 212 of FIGS. 2A-2B above) may be used to perform one or more of the operations in method 350. In another example, one or more AI based models that have been trained and implemented in an AI module (e.g., see AI module 213 of FIGS. 2A-2B above).

As shown, operation 352 includes receiving the supplemented incident data logs. In other words, operation 352 includes receiving any incident data logs determined as being sufficiently relevant in operations 308 and/or 310, and ultimately ingested in operation 312 of FIG. 3A.

With continued reference to FIG. 3B, method 350 advances from operation 352 to operation 354. There, operation 354 includes using supplemental AI based models to evaluate the supplemented incident data logs, and extract metadata therefrom. Depending on the approach, the incident data logs may be in different forms, have different sizes (amounts of data therein), etc. Accordingly, the supplemental AI based models are preferably configured to extract metadata from any desired type of data log. In one example, which is in no way intended to be limiting, the supplemental AI based models are trained to evaluate the supplemented incident data logs using Natural Language Processing (NPL).

This extracted metadata provides valuable insight into the specific incident data logs that are allowed into the system, and which are not. This insight may thereby be used to re-train the AI based models. In other words, metadata extracted by the supplemental AI based models is used to further refine (e.g., improve) the log selection decisions that are made by the AI based models. For instance, the metadata provides key log attributes which enhance filtering accuracy and relevance for incident data log ingestion, e.g., as would be appreciated by one skilled in the art after reading the present description.

In addition to metadata that has been extracted from the supplemented incident data logs, approaches herein may evaluate additional information in order to more accurately re-train the AI based models. For example, operation 356 includes receiving copies of the supplemented incident data logs that have been labeled for usefulness based at least in part on actual use. In other words, the incident data logs may be copied and supplemented (e.g., annotated, marked-up, modified, etc.) based on actual use. In one example, incident data logs determined as being sufficiently relevant in operation 308 of method 300 may be returned with indications of how relevant each data log actually was to system security and/or resolving potential threats.

From operation 356, method 350 advances to operation 358, where the labeled copies of the supplemented incident data logs are used to create a corresponding dataset. Moreover, operation 360 includes using at least the corresponding dataset to re-train the AI based models.

It follows that approaches herein are desirably able to utilize cutting-edge machine learning algorithms for precise log filtering represents a paradigm shift in log management practices. Approaches are also able to achieve automatic adjustment of filtering parameters based on real-time events and threat intelligence injects a dynamic dimension into traditional log management frameworks. This is achieved at least in part by mitigating the escalating costs associated with log management while bolstering the efficacy of incident detection and analysis. For instance, by harnessing the power of machine learning-driven log filtering and adaptive analytics, systems are able to achieve a harmonious balance between cost optimization and security resilience. Machine learning algorithms may serve as the backbone of data log assessment in some approaches, discerning the intrinsic value of each data log source and parameter. Additionally, log retention and analysis levels are dynamically tailored to meet evolving compliance requirements and threat landscapes, ensuring proactive security posture. By integrating compliance mandates and threat management frameworks into the log processing pipeline, approaches herein are able to achieve holistic risk mitigation strategies.

In some approaches, machine learning is used to evaluate past events to determine which parameters of which data logs ultimately proved to be useful. Data logs determined as not being useful (e.g., relevant to system security may be discarded, stored for future analysis, analyzed in real-time, etc., and/or combinations thereof. Moreover, dynamic filtering may be performed, e.g. to only record events that meet some criteria or differ from normal operation. According to a non-limiting example, a dragnet could be automatically widened during suspected incidents. A running algorithm could be aware of compliance recording requirements and/or threat management frameworks. Useful information may also be extracted from determining a source that fed into calculated fields. Approaches are thereby able to balance the cost with usefulness of a data log and/or source thereof.

Some approaches implement a combination of incident severity metrics and usefulness scoring to determine the significance of various data log sources and parameters. Incident severity may be quantified based on predefined criteria, e.g., such as impact on operations, data sensitivity, and regulatory compliance. Each log entry is then subjected to a usefulness scoring mechanism, and incident responders may even assign relevance scores post-event, e.g., based on their investigative insights. These scores serve as pivotal inputs for the algorithms herein, facilitating the prioritization of critical logs over trivial ones.

However, preferred approaches utilize machine learning models. The machine learning models represent a more sophisticated approach, leveraging advanced algorithms to discern patterns and correlations within log data. The models undergo rigorous training using historical log entries and corresponding incident response data. Through iterative learning iterations, parameters of the models are fine-tuned to optimize log filtering decisions based on evolving threat landscapes and operational exigencies. By harnessing the power of artificial intelligence, this model exhibits unparalleled adaptability and predictive capabilities, thereby enhancing the precision and efficacy of log management practices.

The first step in log source identification may involve cataloging and categorizing the myriad sources of log data within a given ecosystem (e.g., system). In one approach, each log source or field is automatically assigned a cost by size. A penalty may be added for unstructured text, as this is more expensive to process. This may entail conducting comprehensive audits and inventory assessments to delineate the scope and diversity of log-generating entities, including network devices, servers, applications, and user activities. Moreover, to facilitate seamless integration and analysis, log data undergoes normalization and standardization processes to ensure uniformity across disparate sources. This involves reconciling differences in log formats, timestamps, and data structures to enable cohesive analysis and interpretation.

The incident handling ticketing system is analyzed to identify which alerts triggered actionable incidents. The relevant alerts are analyzed to identify the contributing log sources/fields. The tickets are processed by NLP, or other appropriate algorithm, to determine which logs were helpful in analyzing and resolving the incident. It should be noted that “helpful” or “relevant” may be scored separately for real-time analytics, and storage for batch processing or future forensics. Other levels are possible, e.g. cold storage, warm storage for batch processing, and real-time analytics. The helpfulness score can be binary, or a continuous variable indicating how useful it was in this particular incident. Metadata could be manually added to the ticket to assist the algorithm if desired.

Metadata is extracted from the ticket to determine severity. A supervised learning algorithm is trained, using log sources as independent variables and incidents as the dependent variable. Log sources are assigned a value between 0 and 1 corresponding to the value assigned previously. The incident severity is assigned a value between 0 and 1. False alarms can be assigned a negative value, indicating how much time/money was wasted.

As noted above, a feature selection algorithm is used to select the most valuable log sources. Sources are penalized according to their cost, as previously determined. The algorithm is run with a lower threshold to determine which logs should be stored, and a higher threshold to determine which should be analyzed in real time. Logs required for compliance purposes are preferably retained. AI may also be utilized to classify each log line on ingest, and assign a helpfulness score on a line-by-line basis.

Some approaches herein are also able to implement feature selection and/or model development. For instance, feature selection may draw upon domain expertise and empirical insights to identify and extract relevant features from the raw log data. These features encapsulate critical attributes and contextual information essential for discerning anomalous patterns and security incidents. The machine learning models also undergo iterative re-training cycles using labelled datasets comprising historical log entries and corresponding incident responses. Various algorithms such as decision trees, random forests, or neural networks are explored and benchmarked to identify the optimal model architecture. Rigorous cross-validation techniques and performance metrics are employed to evaluate model efficacy and generalization capabilities.

Additionally, approaches herein are able to achieve dynamic log filtering and resource allocation across these distributed systems. For example, threshold configuration may be such that granular thresholds and filtering criteria are configured based on organizational priorities, compliance mandates, and risk tolerance levels. These thresholds dictate the inclusion or exclusion of log entries from subsequent analysis and storage, thereby optimizing resource allocation and operational overhead.

Real-time adjustment mechanisms may also be used by the system to continuously monitor environmental variables, including network traffic patterns, threat intelligence feeds, and regulatory updates. In response to emerging threats or compliance requirements, the system dynamically adapts log filtering strategies to ensure timely detection and response to security incidents.

These improvements may further be achieved by easily integrating approaches herein with existing infrastructure. For example, seamless Application Programming Interfaces (API) integration may be achieved using existing SIEM platforms, log aggregation tools, and security orchestration systems to streamline data ingestion and analysis workflows. APIs facilitate bi-directional communication and data exchange between disparate systems, ensuring interoperability and data consistency. Approaches herein are also scalable allowing for performance optimization. Approaches herein are designed to scale seamlessly across distributed environments, accommodating fluctuations in data volume and processing demands. Performance optimization techniques such as parallel processing, distributed computing, and caching mechanisms enhance system responsiveness and throughput, thereby mitigating latency and bottlenecks. Some approaches are also able to achieve continuous monitoring and iterative improvement. For instance, ongoing performance monitoring and KPI tracking may be used by stakeholders to assess the efficacy and return on investment for an implemented solution. Key performance indicators such as mean time to detect (MTTD), mean time to respond (MTTR), and false positive rates are monitored to gauge system effectiveness and operational efficiency. Further still, by implementing feedback loops and model refinement, approaches herein are able to incorporate insights gleaned from real-world incidents and operational feedback back into the AI based model refinement (e.g., re-training) process. This iterative approach fosters continuous improvement and adaptation to evolving threat landscapes and operational requirements, ensuring the solution remains agile and resilient in the face of emerging challenges. By elucidating the intricate nuances of implementation, the solution empowers organizations to translate theoretical concepts into tangible operational frameworks, thereby realizing the full potential of optimized log management practices.

Again, this desirably allows for reduced storage, processing costs, environmental impact, etc. Approaches are able to integrate additional data logs which would otherwise have been excluded due to storage and/or processing costs. Approaches can identify most useful parameters from an existing log source could suggest parameters for a new log source. This is relevant to any log aggregator with associated incidents or alerts, not just SIEMs.

Again, approaches herein are desirably able to apply real-time feedback from operators. The integration of responder feedback into the training and/or re-training process of AI based models is non-obvious, particularly as it leverages real-time labeling of logs post-incident to continually improve future decisions on log retention and analysis. Approaches are also able to achieve adaptive log storage in response to external factors. The process of dynamically widening or narrowing the log capture during heightened risk periods is an innovative adaptation not found in prior art, allowing for proactive scaling of log retention based on threat landscape changes. Furthermore, the concept of applying a cost-benefit analysis through machine learning to decide log retention policies, where the value of logs is calculated based on their incident usefulness and associated storage/processing costs, adds a sophisticated and automated economic layer to log management.

Utilizing NLP to process and extract actionable insights from incident tickets, which then informs the supervised learning models, also provides a more refined approach to optimizing log usage, which is not an obvious extension of traditional SIEM processes. Approaches herein are thereby able to achieve a granular classification of logs (e.g., discard, cold storage, warm storage, real-time analysis) based on dynamic thresholds that adjust according to risk conditions, a feature absent in typical static log storage solutions.

Approaches herein are also desirably able to explicitly reduce storage and energy consumption experienced by a system. Again, supervised and/or unsupervised machine learning algorithms are trained to identify incident data logs that are relevant with respect to system security and send them to cold storage for retention. Approaches herein identify the log sources and/or parameters to exclude from SIEM storage/processing based on the labels provided by the responder after incident and/or compliance requirements.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving incident data logs from a system;
using trained AI based models to:
evaluate the incident data logs in view of log retention thresholds and compliance constraints,
classify the incident data logs based at least in part on their respective utility in incident detection and resolution, and
determine whether any of the incident data logs should be ingested;
causing a feature selection algorithm to supplement the incident data logs output by the trained AI based models; and
ingesting the supplemented incident data logs.

2. The method of claim 1, further comprising:
dynamically adjusting the log retention thresholds in real-time based at least in part on evolving threat intelligence and compliance updates.

3. The method of claim 1, further comprising:
using supplemental AI based models to:
evaluate the supplemented incident data logs, and
extract metadata therefrom; and
using the extracted metadata to re-train the AI based models.

4. The method of claim 3, wherein the supplemental AI based models are trained to evaluate the supplemented incident data logs using Natural Language Processing (NPL).

5. The method of claim 3, further comprising:
receiving copies of the supplemented incident data logs that have been labeled for usefulness based at least in part on actual use;
using the labeled copies of the supplemented incident data logs to create a corresponding dataset; and
using the corresponding dataset to re-train the AI based models.

6. The method of claim 1, wherein the trained AI based models include supervised and/or unsupervised machine learning models.

7. The method of claim 1, further comprising:
in response to determining that one or more of the incident data logs should not be ingested, rejecting the determined one or more incident data logs.

8. A computer program product comprising:
one or more computer-readable storage media; and
program instructions stored on the one or more storage media to perform operations comprising:
receiving incident data logs from a system;
using trained AI based models to:
evaluate the incident data logs in view of log retention thresholds and compliance constraints,
classify the incident data logs based at least in part on their respective utility in incident detection and resolution, and
determine whether any of the incident data logs should be ingested;
causing a feature selection algorithm to supplement the incident data logs output by the trained AI based models; and
ingesting the supplemented incident data logs.

9. The computer program product of claim 8, wherein the operations further comprise:
dynamically adjusting the log retention thresholds in real-time based at least in part on evolving threat intelligence and compliance updates.

10. The computer program product of claim 8, wherein the operations further comprise:
using supplemental AI based models to:
evaluate the supplemented incident data logs, and
extract metadata therefrom; and
using the extracted metadata to re-train the AI based models.

11. The computer program product of claim 10, wherein the supplemental AI based models are trained to evaluate the supplemented incident data logs using Natural Language Processing (NPL).

12. The computer program product of claim 10, wherein the operations further comprise:
receiving copies of the supplemented incident data logs that have been labeled for usefulness based at least in part on actual use;
using the labeled copies of the supplemented incident data logs to create a corresponding dataset; and
using the corresponding dataset to re-train the AI based models.

13. The computer program product of claim 8, wherein the trained AI based models include supervised and/or unsupervised machine learning models.

14. The computer program product of claim 8, wherein the operations further comprise:
in response to determining that one or more of the incident data logs should not be ingested, rejecting the determined one or more incident data logs.

15. A computer system comprising:
a processor set;
one or more computer-readable storage media; and
program instructions stored on the one or more storage media to cause the processor set to perform operations comprising:
receiving incident data logs from a system;
using trained AI based models to:
evaluate the incident data logs in view of log retention thresholds and compliance constraints,
classify the incident data logs based at least in part on their respective utility in incident detection and resolution, and
determine whether any of the incident data logs should be ingested;
causing a feature selection algorithm to supplement the incident data logs output by the trained AI based models; and
ingesting the supplemented incident data logs.

16. The computer system of claim 15, wherein the operations further comprise:
dynamically adjusting the log retention thresholds in real-time based at least in part on evolving threat intelligence and compliance updates.

17. The computer system of claim 15, wherein the operations further comprise:
using supplemental AI based models to:
evaluate the supplemented incident data logs, and
extract metadata therefrom; and
using the extracted metadata to re-train the AI based models.

18. The computer system of claim 17, wherein the operations further comprise:
receiving copies of the supplemented incident data logs that have been labeled for usefulness based at least in part on actual use;
using the labeled copies of the supplemented incident data logs to create a corresponding dataset; and
using the corresponding dataset to re-train the AI based models,
wherein the supplemental AI based models are trained to evaluate the supplemented incident data logs using Natural Language Processing (NPL).

19. The computer system of claim 15, wherein the trained AI based models include supervised and/or unsupervised machine learning models.

20. The computer system of claim 15, wherein the operations further comprise:
in response to determining that one or more of the incident data logs should not be ingested, rejecting the determined one or more incident data logs.
